(19) United States
(12) Patent Application Publication
(10) Pub. No.: US 2012/0022819 A1
(43) Pub. Date: Jan. 26, 2012

(54) Correcting the Motion of a Monochromator

(76) Inventor: Robert J. NORTON, Madison, WI (US)

(21) Appl. No.: 12/843,489

(22) Filed: Jul. 26, 2010

(51) Int. Cl. G06F 19/00; G05B 15/02; G01J 3/18

(52) U.S. Cl. 702/94; 700/275; 356/334

(57) ABSTRACT

A novel means of correcting the motion of an analytical instrument is introduced herein based on the determination of the optimal theoretical parameters in the equation of grating angle versus a selected wavelength. Such a desirable correction method of the present invention not only reduces the amount of wavelength error at the calibration points but also in a novel fashion beneficially corrects for errors in a time-efficient manner between the calibration points to a greater degree than conventional calibration methods.

### BACKGROUND OF THE INVENTION

1. Field of the Invention

The present invention relates to the field of instrumentation. More particularly, the present invention relates to a calibration method that is based on the determination of optimal theoretical parameters to correct the motion of an analytical instrument configured with a diffractive element.

2. Discussion of the Related Art

A monochromator is an optical instrument that transmits a selectable narrow band of wavelengths of light chosen from a wider range of wavelengths available at the input. Such an instrument has many uses in science and in optics because many optical characteristics of a material are dependent on color.

In particular, the amount of light absorption at a particular wavelength of light as provided by a monochromator allows a chemist to determine how much of a particular chemical, enzyme, element, or compound is in the sample being measured. The sample is illuminated with monochromatic light, and light is either absorbed or transmitted according to the presence of a given molecular compound with the proper energy levels proportional to the wavelength of illumination. The resulting absorbance (optical density) or transmittance of the sample is measured.

Monochromators often include a mirror for receiving light from an entrance slit and collimating the light, a diffractive surface for dispersing the light into its individual components, a focusing mirror for receiving those components and refocusing them for presentation at an exit slit. After passing through the exit slit, the light is passed through the sample to be analyzed and directed to a detector to analyze the light.

Generally, the diffractive surface is often a grating configured to receive the incoming parallel light that can contain multiple different wavelengths and disperses such multiple wavelengths in space at slightly different angles dependent upon the particular wavelength and design of the overall system. All that is required to isolate a wavelength of choice so as to direct it out of the monochromator is to adjust the grating, more often by finely adjusting the grating so that a desired wavelength passes through the exit slit while undesired wavelengths are blocked. In many a number of conventional instruments, such a manipulation is by way of a servomotor as controlled by a computer. The monochromator before use is calibrated by using a lamp with a well defined spectral line to aid in the adjustment of the grating position until that well defined spectral line is directed out of the exit slit. The grating's position is then set to “display” that wavelength as enabled by the calibration procedure. In a majority of modern instruments this is done automatically.

However, it is to be appreciated that while the ultimate goal of an operator in using such an instrument is to measure accurately a desired wavelength λ, it is to be understood that what is actually recorded is a given motor micrometer reading z calibrated to provide a given desired wavelength λ. Wavelength errors are thus usually caused by a failure of the monochromator indexing mechanism to move the grating to the correct rotation angle. In particular, if the monochromator does not accurately provide the correct motor micrometer reading z so as to select the desired wavelength, efficiency peaks, anomalies, etc., will appear at the wrong spectral position.

On an automated instrument, a significant error may result unless the instrument has the ability to “hunt” for the efficiency peak. Most computer based monochromator systems employ correction factors or calibration tables in firmware to correct for systematic wavelength errors. To ensure wavelength accuracy, periodic wavelength calibration is thus often required in a time-consuming manner using a calibration lamp or other spectral line source. In an ideal instrument (i.e., without bench-top imperfections) such a calibration procedure using a known emission source is rather straightforward. However, in the real world, it is generally known to those of ordinary skill in the art that a fast yet highly accurate relationship between z and λ at the calibration points is necessarily required for interpreting further measurements accurately and uniformly over the entire range of operation of the instrument.

Accordingly, a need exists for an improved calibration method to reduce errors at the calibration points and to also correct bench-top errors at the calibration points to greater degree than prior art methods. The present invention is directed to such a need.

Background information on a system and method for calibrating the drive mechanism on a spectroscopy instrument, is described and claimed in, U.S. Pat. No. 7,561,266 B2, entitled, “CALIBRATED SPECTROSCOPY INSTRUMENT AND METHOD,” issued Jul. 14, 2009, to Hammer et al., including the following, “[t]he spectroscopy instrument includes a monochromator having a drive mechanism comprising a pair of spur gears for rotating a diffraction grating of the monochromator for selecting a desired wavelength. The drive mechanism is calibrated to account for eccentricities in the spur gears to provide an accurate conversion between selected angular settings for the drive mechanism and the wavelength of the diffracted light from the monochromator. The drive mechanism comprises a pinion spur gear and a main spur gear which each have an AGMA (American Gear Manufacturers' Association) rating of at least 10, which allows errors due to random tooth to tooth variations to be neglected. A calibration algorithm is derived which is based on the error due to eccentricities in the spur gears following a precise geometric cyclic pattern.”

Background information on a method of calibrating a monochromator to compensate for mechanical imperfections, is described and claimed in, U.S. Pat. No. 4,779,216, entitled, “SYSTEM FOR CALIBRATING A MONOCHROMATOR” issued Oct. 18, 1988, to Collins, including the following, “[a] method for calibrating a monochromator to compensate for mechanical imperfections in its diffraction grating and grating drive assembly employs a two stage interactive procedure which permits the use of small (0.2 nm) spectral regions for the identification of emission lines. An iterative, self-consistent, discrete Fourier transform is used for the determination of multiple positioning correction terms. When the Fourier calculations are completed, the results of the calibration procedure are presented by the system to the analyst for acceptance. If accepted, the positioning error of the primary calibration line is measured, stored and used by the system to maintain a zero centered distribution of positioning errors each time the monochromator is reinitialized.”

Background information on another method that calibrates a monochromator to compensate for mechanical imperfections, is described and claimed in, U.S. Pat. No. 5,557,404, entitled, “SPECTROPHOTOMETER WITH A SYSTEM FOR CALIBRATING A MONOCHROMATOR” issued Sep. 17, 1996, to Matsui et al., including the following, “[i]rregular mechanical imperfections caused by constituent parts of a monochromator in connection with wavelength setting are compensated by calibrating the monochromator according to the present invention. A whole measurable spectral range in the monochromator is divided into a plurality of spectral regions by a plurality of calibration wavelengths. Errors between apparent wavelengths set theoretically and their true wavelengths are obtained with respect to the respective calibration wavelengths. Error functions in connection with the respective spectral regions are calculated on the basis of the array of the obtained errors. An element to be detected in a sample is measured under a wavelength the error of which has been compensated for by use of an error function in a spectral region associated with a wavelength to be detected.”

### SUMMARY OF THE INVENTION

The present invention provides a novel means of correcting the motion of a monochromator (i.e., correcting bench-top errors for the entire instrument, such as, optical component variations, mechanical variations, etc.) based on the determination of the optimal theoretical parameters in the equation of grating angle versus a selected wavelength. Such a desirable correction method of the present invention reduces the amount of wavelength error at all points within a desired spectrum in a time-efficient manner (e.g., from mere seconds up to a minute) and to a greater degree than prior conventional calibration methods.

As one aspect, the present invention is directed to a method of calibrating a spectroscopy instrument having a diffraction grating to include: providing one or more selected light sources having at least two intensity peaks separated within their output spectra, wherein the at least two intensity peaks correspond to a number of steps of a given drive means; determining a positioning error based on the difference between the number of steps and a desired number of steps to find a given wavelength as provided by a grating equation of the form:

(angle)=(steps)=K₀+K₁*arcsine(K₂*Wavelength);

wherein:
(angle) is the grating angle which maps to a given number of (steps) in moving the given drive means so as to provide for a desired Wavelength,
K₀ is a home angle constant,
K₁ relates to proportional changes that comprise mechanical gear ratios and micro-stepping constants, and
K₂ is a calibration constant that includes a function of the line spacing of the diffraction grating and the included angle of the light path for a particular spectroscopy instrument; and setting K₂ to a new value for use in the grating equation; repeating steps (a) and (b) until the positioning error is acceptable; and saving a desired K₂ calibration constant for use in the grating equation so as to operate the spectroscopy instrument.

Another aspect of the present invention is directed to: an analytical instrument that includes: a diffractive element; a given drive means; a computer configured to operate the analytical instrument by way of: rotating the diffractive element to a desired step position so as to provide a desired wavelength in accordance with the following calibration equation:

(angle)=(steps)=K₀+K₁*arcsine(K₂*Wavelength);

wherein:
(angle) is the diffractive element angle which maps to a given number of (steps) of the given drive means so as to provide for a desired Wavelength,
K₀ is a home angle constant,
K₁ relates to proportional changes that comprise mechanical gear ratios and micro-stepping constants, and
K₂ is a calibration constant that includes a function of the line spacing of the diffractive element and the included angle of the light path for a particular spectroscopy instrument.

Accordingly, the novel calibration approach provided herein works because it is using the native form of the grating equation so as to fine-tune the working of the optical bench that is being calibrated. In particular, by essentially calibrating to find a predetermined good value of the K₂ constant inclusive in the native form of the grating equation, it is only necessary to find one reference wavelength at power up in setting an instrument's home position so as to accurately direct other desired wavelengths across a given calibrated spectrum. This is in contradistinction to conventional calibration methods that necessarily use interpolation between the calibration points to provide adequate results at the calibration points but with undesired errors occurring between such points.

### BRIEF DESCRIPTION OF THE DRAWINGS

FIG. 1 shows an example instrument configured with a diffractive element that can be beneficially calibrated by the methods of the present invention.

FIG. 2 shows a plot of angle versus wavelength to illustrate acquired data approximated by a linear fit.

FIGS. 3A and 3B shows a piecewise linear fit curve to a given set of calibration points and a plot of a correspondence curve.

FIG. 4 shows an example calibration flowchart method of the present invention.

### DETAILED DESCRIPTION

In the description of the invention herein, it is understood that a word appearing in the singular encompasses its plural counterpart, and a word appearing in the plural encompasses its singular counterpart, unless implicitly or explicitly understood or stated otherwise. Furthermore, it is understood that for any given component or embodiment described herein, any of the possible candidates or alternatives listed for that component may generally be used individually or in combination with one another, unless implicitly or explicitly understood or stated otherwise. Moreover, it is to be appreciated that the figures, as shown herein, are not necessarily drawn to scale, wherein some of the elements may be drawn merely for clarity of the invention. Also, reference numerals may be repeated among the various figures to show corresponding or analogous elements. Additionally, it will be understood that any list of such candidates or alternatives is merely illustrative, not limiting, unless implicitly or explicitly understood or stated otherwise. In addition, unless otherwise indicated, numbers expressing quantities of ingredients, constituents, reaction conditions and so forth used in the specification and claims are to be understood as being modified by the term “about.”

Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

### General Description

As known to those of ordinary skill in the art, before taking a measurement using an analytical instrument configured with a diffractive element, such as, for example, a monochromator/spectrophotometer, it is prudent to first measure a reference light source (e.g., Mercury light source). If the known desired lines are detected at their specified wavelength, the actual experiment can follow. If there is drift between the expected values and the results, the instrument must be recalibrated and the calibration verified by re-measuring the reference source with the monochromator/spectrophotometer in an acquire-type of mode. Depending on the desired accuracy of the results, the calibration step might be postponed or programmed to occur on a regular basis (hourly, daily, weekly, etc.) after developing a calibration procedure based on statistical data of the errors of the instrument.

Accordingly, to address accuracy and time consuming calibration concerns known in the art, the present invention provides for a novel rapid calibration procedure that corrects for the motion of the analytical instrument (e.g., a monochromator/spectrophotometer) based on first determining the optimal theoretical parameters in the equation of grating angle versus a desired selected wavelength. Such a novel method fine-tunes the working of the optical bench that is being calibrated in time frames that involves merely seconds by allowing for calibration at a single known well-defined wavelength at power up after the initial calibration has been performed.

### Specific Description

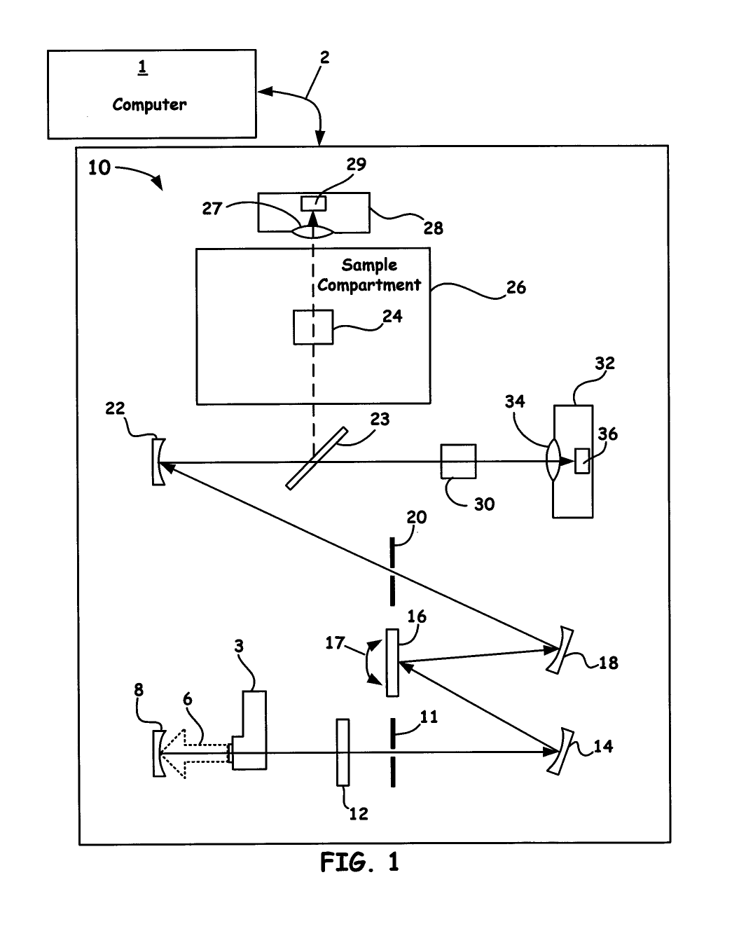

FIG. 1 shows an illustrative embodiment of an analytical instrument, (e.g., a monochromator/spectrometer) of the present invention, generally designated by the reference numeral 10, which can be benefited by the calibration methods disclosed herein. As shown in FIG. 1, a calibration light source 3 is provided with the instrument 10. Often, light source 3 is a Xenon flash light source to be used in normal operation and/or a Mercury light source (e.g., for calibration or verification of wavelengths) although other light sources can also be utilized as long as they can provide desired well-defined wavelengths (i.e., atomic emission lines over a desired spectral region) separated in their spectra so as to correspond to a large movement (e.g., a large number of micro-steps) of the drive means of the present invention. For example, low-pressure Mercury vapor light source has a number of intense, narrow and well-identified emission bands that cover the UV-VIS spectral range. A high-pressure arc lamp (e.g., Xenon or Mercury) has a very small arc region between anode and cathode, producing high intensity broad spectra radiation from what is essentially a point source. Other lamps such as Argon-filled lamps are used for monitoring and calibrating in the NIR spectral range that can be combined with other sources when needed. In particular, it is common to use a combination of gases in order to manufacture reference light sources to cover extended spectral ranges. For example, Argon-Mercury lamps cover a spectral range from 253 nm to 1700 nm.

Thus, a chosen light source 3 is configured to direct light 6 (also denoted as the larger dashed arrow) to a first optical reflector 8 designed to redirect light 6 through a filter assembly 12 configured to block lower wavelengths of emission whose second or third diffractive orders resulting in the instrument can adversely affect light of any of the one or more desired analytical wavelengths. Moreover, because of the arrangement of light source 3 and first optical reflector 8, light 6 can be directed in a converging manner on-axis through the center of an entrance slit 11 after transmission through assembly 12 in a configured manner to limit aberrations and to optimize the footprint of instrument 10.

Light 6, after passing through slit 11 is then received by a second optical reflector 14 whose focal plane is designed at the range of entrance slit 11 so that upon reflection, light 6 is collimated and beneficially directed to a diffractive element 16. Diffractive element 16 is desirably a grating. Example gratings that can be incorporated with the methods of the present invention include, but are not limited to, ruled gratings, Sheridan gratings, holographic gratings, replicated gratings, etched lamellar gratings, and Echelle gratings. The groove profile of the grating utilized depends on the method of manufacture and differs among gratings, such as ruled gratings (triangular profiles), holographic gratings (often sinusoidal profiles), and etched lamellar gratings (rectangular or fin profiles) and factors into the calibration procedure disclosed herein.

As part of the design of instrument 10, diffractive element 16 is coupling to a drive means (not shown), e.g., a stepper motor, to enable rotation about a vertical axis (as denoted by the bi-directional arrows 17). In the example embodiment shown in FIG. 1, a Permanent Magnet (PM) stepper motor capable of providing desired micro-steps of resolution is often desirable, though one of ordinary skill in the art can also appreciate that the present invention may alternatively utilize variable reluctance motors, brushless DC motors, hybrid stepper motors, or servo motors. As another beneficial arrangement, reduction gear mechanisms, direct drive mechanisms, optical-encoders, etc., as known to those skilled in the art, can also be integrated into the instrument shown in FIG. 1 to provide, if desired, the necessary resolution of the angular rotation of the diffraction grating as directed by a given motor.

Such configurations enable diffractive element 16 to receive light 6 at an intersecting predetermined angle as directed by second optical reflector 14 in order to further direct a desired wavelength to a sample 24 arranged in a compartment 26 as discussed in detail hereinafter. Specifically, to direct light 6 to sample 24, diffractive element 16 splits received light 6 into individual desired wavelength components and directs such components to a third optical reflector 18 having a curvature arranged to direct focused diffracted light to an exit slit 20 by way of rotating diffractive element 16 about the vertical axis via a drive means (not shown) as generally discussed above. Light 6 directed out of exit slit 20 is thereafter received by a fourth optical reflector 22 and redirected to an optical beam splitter 23. Beam splitter 23 enables a portion of the light to be directed through a reference sample 30 and a first assembly 32 having, but not limited to, coupling optics 34 and a first detector 36. The other predetermined portion of light (as denoted by the dashed lined arrow) is directed so as to be received by sample 24 so that its distinctive spectra can be collected by a second assembly 28 configured with, for example, its own respective coupling optics 27 and detector 29.

The light as collected by detectors 29 and 36 is thereafter inputted to a computer or other electronic processor or controller 1 in a desired electrical format, e.g., as raw integral digitized values, to enable the embedded software within the computer 1 to achieve the maximum precision when processing the data. The coupling 2 between the instrument 10 and the computer 1 is by way of any I/O means for carrying out operations. Often the coupling 2 includes a USB port although the application software can interface with the instrument 10 by way of a Virtual COM port, i.e., the application software can access the USB device in the same way as it would access a standard COM port. Such coupling means provides programmatic control instruction and operational data (feedback) via the embedded software of the present invention in addition to any other necessary electronic manipulation. The computer 1 is also often electronically coupled to one or more other output devices, such as display screens, printers, etc. and/or one or more other input devices, such as keyboards, internet connections, etc.

Instructions to start predetermined measurements, the analysis of data, etc., are often primarily executed by the computer 1 shown in FIG. 1. However, operations can also be executed under instructions stored on a machine-readable medium (e.g., a computer-readable medium). A computer-readable medium, in accordance with aspects of the present invention, refers to mediums known and understood by those of ordinary skill in the art, which have encoded information provided in a form that can be read (i.e., scanned/sensed) by a machine/computer and interpreted by the machine's/computer's hardware and/or software.

In particular, the computer-readable media can often include local or remote memory storage devices, such as, but not limited to, a local hard disk drive, a floppy disk, a CD-ROM or DVD, RAM, ROM, a USB memory device, and even any remote memory storage device known and understood by those skilled in the art. The invention may also be practiced in distributed computing environments, wherein associated tasks are performed by remote processing devices that are linked through a communications network (e.g., wireless).

Turning back to instrument 10, as shown in FIG. 1, it is to be noted that the point of interest for the purposes of the present invention is that by varying the position of diffractive element 16 via rotation, the wavelength of light passing through exit slit 20 is selected. The rotation of diffractive element 16, as generally discussed above, is often provided by a drive mechanism, such as, a stepper motor mechanism (not shown), more often a high speed stepper motor sine bar drive mechanism. Such a configuration ensures desired repeatability and stability by rotating diffractive element 16 to scan desired wavelengths of a given light source that is directly proportional to the sine of the scan angle through which the element rotates. The mechanism itself along with all of the other bench top variability of the instrument 10, as shown by all of the components in FIG. 1, is in operation, beneficially calibrated by the methods of the present invention, as disclosed herein, so as to accurately (i.e., within 0.05 nm) identity a particular desired wavelength, as discussed below.

### Grating Equation

The basic geometric properties of any optical grating follow from the equation (i.e., the Grating Equation) that expresses the condition for constructive interference from successive periodic elements on a surface so as to relate the incidence angle θᵢ, the diffracted angle θ_{d} for order m, and the ratio of the incident wavelength λ to groove spacing d and is formulated as (Equation 1):

mλ=d(sin θᵢ+sin θ_{d}) (1).

In the present invention, a desired wavelength from a light source can thus be directed via diffractive orders in to the sample 24, as shown in FIG. 1, by rotating diffractive element 16 about an axis coincident with its central ruling at a scan angle measured from the grating normal to the bisector of the incident and diffracted beams, with the directions of incident and diffracted light remaining unchanged.

### Bench Theory

In any event, the ultimate goal of an operator in using an instrument, such as that shown in FIG. 1, is to accurately measure a desired wavelength λ but what is actually recorded is a given motor micrometer reading z calibrated so as to enable the mapping of the micro-steps to a desired wavelength λ. In particular, it is desired to translate a requested wavelength (e.g., nanometers) for a measurement into a specific micro-step of an instrument's motor so as to result in the grating angle of the dispersive element being accurately set to a function of any desired wavelength.

Accordingly, such a translation assumes a simplified form of Equation 1 as now shown by Equation 2, wherein:

Scan Angle=(steps, e.g., micro-steps)=F(desired wavelength); (2)

Equation 3 shows the theoretical form of Equation 2, as utilized herein, by collecting constant terms:

Scan Angle=(micro-steps)=K₀+K₁*arcsine(K₂*Wavelength); (3)

wherein:
K₀ is the home angle (wavelength=0);
K₁ relates to proportional changes, such as, but not limited to mechanical gear ratios and micro-stepping constants (e.g., micro-steps per full step).
K₂ includes a function of the line spacing of the diffraction grating and the included angle of the light path for a particular bench instrument. The arcsine function is applied to factors such as grating line spacing and includes angle of the beam in the instrument.

It is to be appreciated that deviations that are outside the form of the equation cannot be corrected fully by the equation. Such effects can result from poor gear teeth engagement, improperly centered drive sprockets, etc. Moreover, the inventor of the present invention found through experimentation that the effects of the variation of K₁ from the design constant are small for properly built instruments and that calibration on any given instrument requires primarily assigning a value to K₂.

Accordingly, as part of the novel aspects of the present, with a good value of K₂ available to the instrument's firmware, each time the instrument powers up, it is only necessary to find one reference wavelength to set the value of for K₀. This allows the present invention to rapidly initialize (seconds up to about less than a minute) with consistent accuracy (less than about 1/20 nm) across any predetermined spectrum.

It is also to be noted that during a calibration procedure of the present invention, a lookup table is created in a memory device (e.g., non-volatile RAM) to establish, for example, the relationship between a number of micro-steps required for an incorporated stepper motor and a wavelength that is established by the theoretical form of Equation 3, as shown above.

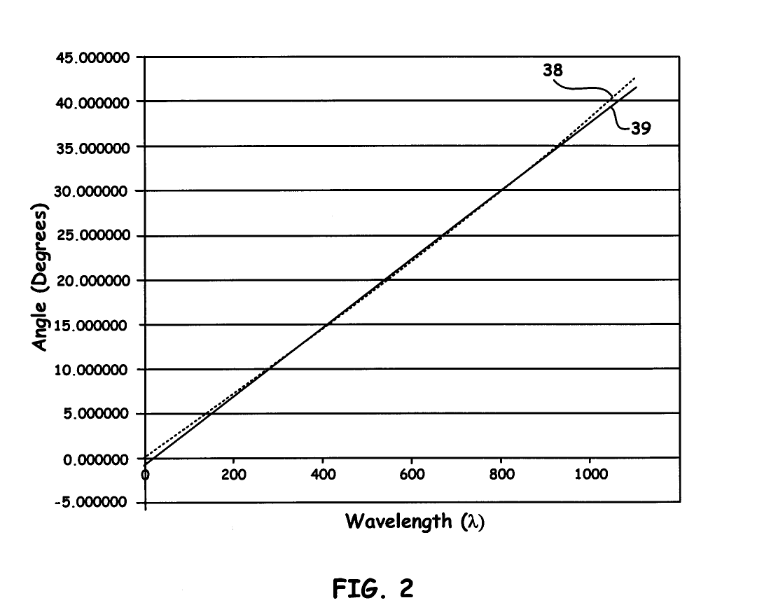

Before detailing the determination of K₂, it is instructive to show the limitations of methods that incorporate curve fitting routine to interpolate data between calibration points. As an example, it is known that wavelength vs. angle for a particular diffractive element can be found using a process that approximates the acquired field data with a straight line. FIG. 2 shows such a result wherein the actual acquired data 38 (denoted as a dotted line) is approximated by a linear fit 39 (denoted as a solid line). However, it is to be appreciated by the discussion that follows that there are some errors that need to be corrected, especially for high accuracy applications (down to about less than 1/20nm), when using such an approximation.

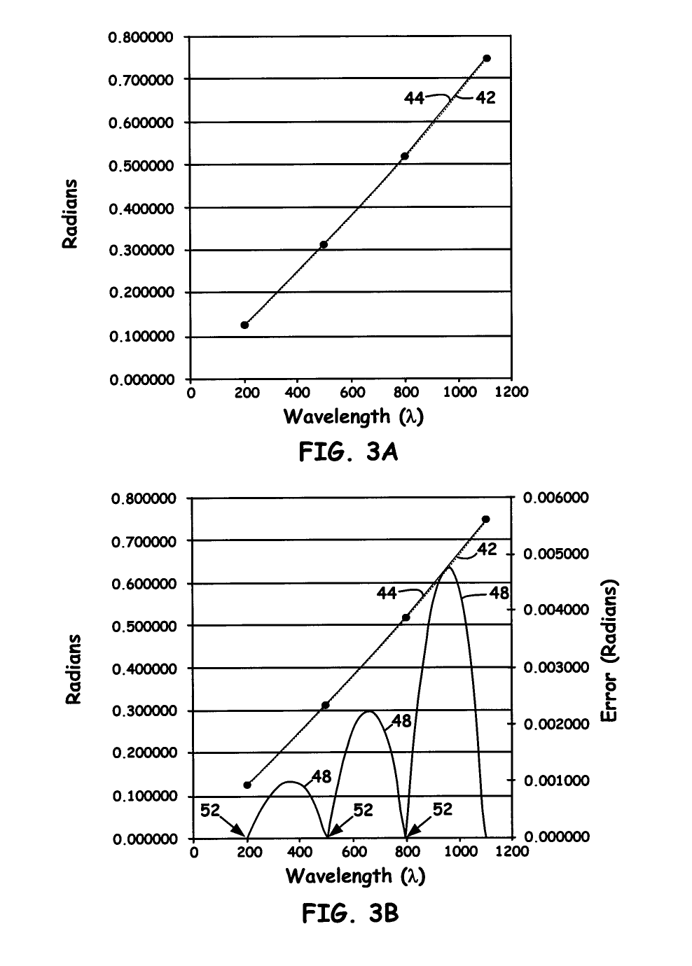

FIG. 3A shows a plot of radians versus wavelength for a set of calibration data points (denoted as dark circles). Such a method is a natural way to correct for the deviation from a straight line by calibrating at a few points. In particular, FIG. 3A shows two curves, the first is an example 44 linear interpolation to approximate readings between the points, which somewhat reduces the overall error. However, as discussed below, the error away from the calibration points is unknown. The second curve is a correspondence curve 45 (denoted as a dotted line), which is a mapping of micro-steps with wavelength (i.e., a mapping of the grating angle and the selected wavelength). This is a scaled arc-sine type of curve. The slight areas between the curves, while somewhat hard to see in FIG. 3A, nonetheless represent the expected error between the actual system performance (i.e., the actual number of micro-steps to find a given line) and the approximation via, for example, a polynomial fit of the data.

FIG. 3B again shows the same plot 44 shown in FIG. 3A (i.e., a piece-wise linear fit) and the correspondence curve 45 using the 4 illustrated calibration points (denoted as dark circles). However, the line denoted by the reference character 48 now is utilized to illustrate an expansion of the error magnitude (note the units on the right-hand side of the plot of FIG. 3B) when using a piecewise linear fit. Thus, line 48 provides the reader with a further appreciation that although the theoretical error can be zero 52 at the calibration points, the error can still be relatively large at locations over the intervals between points. As a result, a given instrument, such as the example instrument shown in FIG. 1, can provide uneven accuracy at different wavelengths when not using the calibration method of the present invention.

### K₂ Determination Method

In determining K₂, as shown in Equation 3 above, it is to be noted that instead of trying to apply corrections to a linear fit, the present invention in a novel fashion finds the form of the theoretical equation that is the best fit to a particular instrument. In particular, this involves finding a good value for K₂ to compensate for items, such as, but not limited to, individual grating line spacing and optical path angles as defined by manual mirror adjustments.

In order to find a value of K₂ that represents the mechanics and optics of a particular instrument, known reference wavelengths are still required. In this case, the reference wavelengths can be obtained from the natural emission spectra of an established light source known in the art, such as, but not limited to, a Xenon gas light source, relying on published wavelength data. Starting with an initial nominal value for K₂, the difference in wavelength between known emission peaks is measured. Based on the difference, the K₂ factor is corrected. By using a difference rather than exact values, errors in initial K₀ values can be eliminated. Beneficially, once the K₂ factor for a particular instrument is known, only a single wavelength calibration is needed to find K₀ accurately. This allows relatively rapid calibration, uniform accuracy of down to about 1/20 nm across a given spectrum, and with less fluctuation.

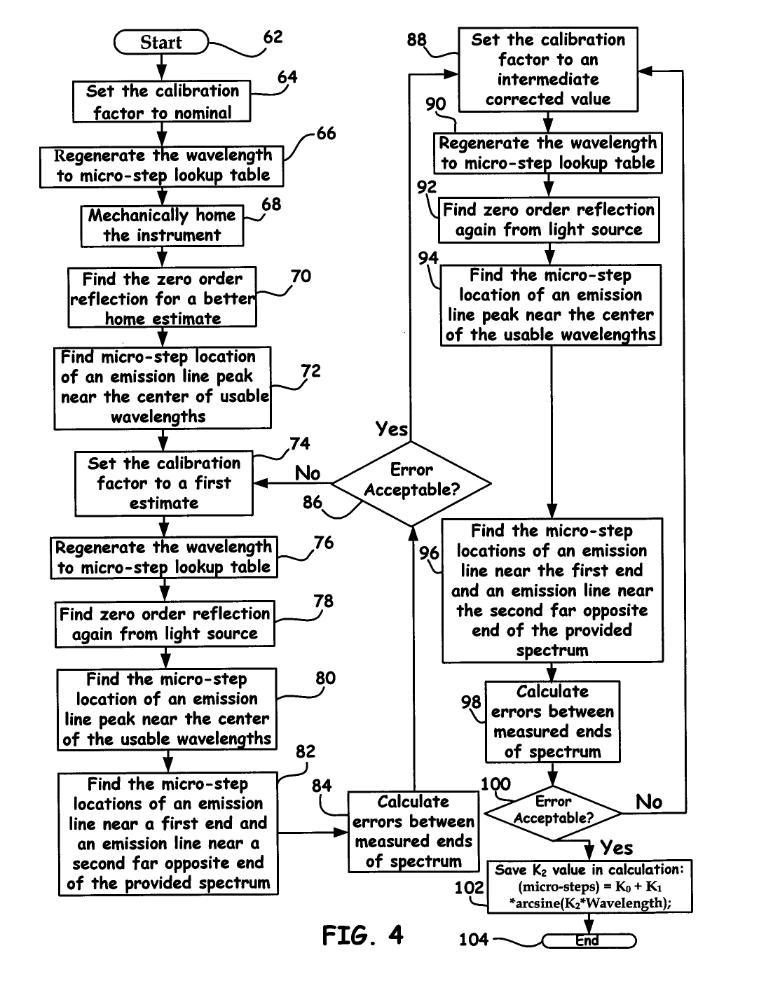

The present invention is to be more fully understood by reference to the example calibration method shown in FIG. 4, as related to the example system shown in FIG. 1, which is intended to be illustrative of the present invention, but not limiting thereof.

The goal of the calibration method of the present invention is to find a value for the correction constant K₂ in Equation 3, as shown above, that converts a desired wavelength into a micro-step. A user often can generate this number using, for example, a Xenon lamp (often the standard lamp used in normal operation) and/or using, for example, a Mercury lamp (often used for calibration or verification of wavelengths). Such a process is basically the same in either case, but a few particulars are changed, as the emission lines of the sources fall in different locations. The exact emission lines used and the number of lines are not critical to the process, but selecting at least two intensity lines (peaks) furthest apart, e.g., peaks shown in the second and third columns of Table 1 for a given lamp (297.93 nm and 881.94 nm for Xenon), so that they have a large number of micro-steps between them allows for an accurate analysis.

TABLE 1

| | Xenon (nm) | Mercury (nm) |
|---|---|---|
| Central wavelength | 529.22 | 546.07 |
| Ultraviolet end wavelength | 297.93 | 296.73 |
| Infrared end wavelength | 881.94 | 871.66 |

In implementation of the calibration procedure to find the value of K₂ to be utilized in Equation 3, the embedded software within the computer 1 of FIG. 1 starts the process, as shown by reference character 62 of FIG. 4, sets the calibration factor to a nominal value (e.g. 1.0000), as shown in block 64, and then regenerates a micro-step lookup table, as shown in block 66. The instrument 10, of FIG. 1 then is directed to a mechanical home, as shown in block 66, against a device (e.g., a micro switch) to provide a crude homing position. Next, as shown in block 70, the zero order reflection by the diffractive element 16 of FIG. 1 from a desired light source is provided by the instrument 10 of FIG. 1 to enable a better home estimate. The software then directs the instrument 10 to find the micro-step location of an emission line peak near the center of the usable wavelengths of the desired lamp, as shown in block 72 of FIG. 4. This central peak micro-step number as a distance from the zero order generates the first approximation of the calibration number. This number is utilized to reliably find the peaks to be used in generating the final value.

The method shown in FIG. 4 via software thus sets the calibration factor to a first estimate 74 as provided above, regenerates the wavelength to micro-step lookup table again 76 and again manipulates the instrument 10 of FIG. 1 to find the zero order reflection 78 of the desired light source. Thereafter, the instrument 10 is manipulated to once again find the micro-step location of an emission line peak near the center of the usable wavelengths. This step, as shown by block 80, gives a reliable offset in the current micro-step lookup table.

The next steps include finding the micro-step locations of an emission line peak near a first far end of the spectrum (e.g., the ultraviolet end of the spectrum) and an emission line peak near a second far opposite end of the spectrum (e.g., the infrared end of the spectrum), as shown in block 82, and measuring the error in the micro-step distance between such first and second ends of the spectrum (e.g., the ultraviolet and infrared peaks), as shown in block 84. Based on that error a decision is made at branch 86 (the acceptable error is set by the operator) to repeat steps starting at block 74 or alter the current calibration K₂ factor so as to set the calibration factor to an intermediate corrected estimate, as shown by block 88 in FIG. 4. It is to be noted again that such an error is the difference between the theoretical value found by the form of Equation 3 and the actual number of steps to provide for a given line at opposite ends of the spectrum.

Once again, the system of FIG. 1 regenerates a wavelength to micro-step lookup table 90 based on the new K₂ value and again manipulates the instrument 10 of FIG. 1 to find the zero order reflection 92 of the desired light source. Thereafter, the instrument 10 is manipulated to find the micro-step location of an emission line peak near the center of the usable wavelengths, as shown by block 84.

The next steps again include finding the micro-step locations of an emission line peak near a first far end of the spectrum (e.g., the ultraviolet end of the spectrum) and an emission line peak near a second far opposite end of the spectrum (e.g., the infrared end of the spectrum), as shown in block 96, and measuring the error in the micro-step distance between such first and second ends of the spectrum (e.g., the ultraviolet and infrared peaks), as shown in block 98. A decision is made at branch 100 as to the predetermined acceptable error value of whether to repeat steps, as shown at block 88, or save the calibration K₂ in non-volatile memory for use on subsequent restarts, as shown by block 102 in FIG. 4, so as to be utilized in the overall calibration calculation (e.g., Equation 3). The process if it reaches this point then terminates, as shown by reference character 104 after generating a corresponding wavelength to micro-step lookup table (not shown).

Now that the calibration factor is known, instrument startup is much faster. Thus, to operate the instrument thereafter, a user instructs the system to:
1. Mechanically home the instrument against a micro switch for a crude home.
2. Find the zero order reflection from the lamp for a better home estimate.
3. Find central wavelength peak, and shift the home location (K₀) so that the wavelength is correct.

1. A method of calibrating a spectroscopy instrument having a diffraction grating, comprising:
(a) providing one or more selected light sources having at least two intensity peaks separated within their output spectra, wherein said at least two intensity peaks correspond to a number of steps of a given drive means;
(b) determining a positioning error based on the difference between said number of steps and a desired number of steps to find a given wavelength as provided by a grating equation of the form:
(angle)=(steps)=K₀+K₁*arcsine(K₂*Wavelength);
wherein:
(angle) is the grating angle which maps to a given number of (steps) in moving said given drive means so as to provide for a desired Wavelength,
K₀ is a home angle constant,
K₁ relates to proportional changes that comprise mechanical gear ratios and micro-stepping constants,
K₂ is a calibration constant that includes a function of the line spacing of the diffraction grating and the included angle of the light path for a particular spectroscopy instrument; and
(c) setting K₂ to a new value for use in said grating equation;
(d) repeating steps (a) and (b) until said positioning error is acceptable; and
(e) saving a desired final K₂ calibration constant for use in said grating equation in operation of said spectroscopy instrument.

2. The method of calibrating a spectroscopy instrument of claim 1, further comprising:
mechanically homing said spectroscopy instrument;
finding a zero order reflection of said one or more selected light sources;
finding a central wavelength peak;
shifting the home location (K₀) and
finding a desired wavelength by way of said grating equation using said saved desired final K₂ calibration constant.

3. The method of calibrating a spectroscopy instrument of claim 1, further comprising:
setting the K₂ calibration constant to a nominal value in providing calculated steps using said grating equation;
generating a step to lookup table;
mechanically homing said spectroscopy instrument;
finding a zero order reflection for a better home estimate;
finding a step location of an emission line peak near the center of usable wavelengths provided by said one or more selected light sources;
setting said K₂ calibration factor to a first estimate in providing calculated steps using said grating equation;
regenerating a step to lookup table;
finding a zero order reflection again for a better home estimate;
finding a step location of an emission line peak near the center of usable wavelengths provided by said one or more selected light sources; and
finding the step locations of an emission line peak near a first end and an emission line peak near a second far opposite end of said output spectra, wherein said emission line peak near a first end and said emission line peak near a second far opposite end correspond to said at least two intensity peaks.

4. The method of calibrating a spectroscopy instrument of claim 1, further comprising:
saving said desired final K₂ calibration constant in non-volatile memory.

5. The method of calibrating a spectroscopy instrument of claim 1, wherein said given drive means comprises at least one motor selected from: a stepper motor, a variable reluctance motor, a brushless DC motor, a hybrid stepper motor, and a servo motor.

6. The method of calibrating a spectroscopy instrument of claim 1, wherein said given drive means comprises at least one drive mechanism selected from: a reduction gear mechanism, a direct drive mechanism, and a sine bar mechanism.

7. The method of calibrating a spectroscopy instrument of claim 1, wherein said provided one or more selected light sources comprises at least one source configured to provide atomic emission lines over a desired spectral region.

8. The method of calibrating a spectroscopy instrument of claim 1, wherein said provided one or more selected light sources comprises at least one source selected from: a Mercury light source, a Xenon flash light source, an Argon light source, and an Argon-Mercury light source.

9. An analytical instrument, comprising:
a diffractive element;
a given drive means;
a computer configured to operate said analytical instrument by way of: rotating said diffractive element to a desired step position so as to provide a desired wavelength in accordance with the following calibration equation:
(angle)=(steps)=K₀+K₁*arcsine(K₂*Wavelength);
wherein:
(angle) is the diffractive element angle which maps to a given number of (steps) of said given drive means so as to provide for a desired Wavelength,
K₀ is a home angle constant,
K₁ relates to proportional changes that comprise mechanical gear ratios and stepping constants, and
K₂ is a calibration constant that includes a function of the line spacing of the diffractive element and the included angle of the light path for a particular spectroscopy instrument.

10. The analytical instrument of claim 9 wherein said given drive means comprises at least one drive mechanism selected from; a reduction gear mechanism, a direct drive mechanism, and a sine bar mechanism.

11. The analytical instrument of claim 9 wherein said given drive means comprises at least one motor selected from: a stepper motor, a variable reluctance motor, a brushless DC motor, a hybrid stepper motor, and a servo motor.

12. The analytical instrument of claim 9 wherein said diffractive element comprises at least one diffractive grating selected from: a ruled grating, a Sheridan grating, a holographic grating, a replicated grating, an etched lamellar grating, and an Echelle grating.

13. The analytical instrument of claim 12 wherein said at least one diffractive grating has at least one groove profile selected from: a triangular profile, a sinusoidal profile, and a rectangular profile.

14. The analytical instrument of claim 9 wherein said analytical instrument comprises at least one scientific instrument selected from: a spectrometer and a monochromator.
